(19) United States
(12) Patent Application Publication
(10) Pub. No.: US 2004/0052183 A1
(43) Pub. Date: Mar. 18, 2004

(54) Data recording and reproducing apparatus, method, and medium including computer readable code therefor

(75) Inventors: Jong-Hwa Yu, Gyeonggi-do (KR); Pyong-Yong Seong, Seoul (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-city (KR)

(21) Appl. No.: 10/636,668

(22) Filed: Aug. 8, 2003

(30) Foreign Application Priority Data
Sep. 18, 2002 (KR) 2002-56816

(51) Int. Cl. G11B 7/00

(52) U.S. Cl. 369/53.24; 369/59.11; 369/47.5

(57) ABSTRACT

A data recording or recording and reproducing apparatus and method for improving recording quality by recording and/or reproducing data which controls the varying of a recording optical power level based on the recording speed when recording data in a disc-type recording medium. The data recording apparatus includes a memory for storing discrimination information for discriminating a disc type as well as corresponding read power level information for each recording speed, a pickup driving unit for receiving information read out from the disc from a pickup or outputting a signal for controlling the pickup, and a system control unit for receiving discrimination information of an inserted disc from the pickup driving unit, determining the read power level based on the power information for each recording speed corresponding to the disc discrimination information, and outputting a signal reflecting the determined read power to the pickup driving unit.

### CROSS-REFERENCE TO RELATED APPLICATIONS

This application claims the priority of Korean Patent Application No. 2002-56816 filed on Sep. 18, 2002, in the Korean Intellectual Property Office, the disclosure of which is incorporated herein in its entirety by reference.

### BACKGROUND OF THE INVENTION

1. Field of the Invention

The present invention relates to apparatuses for recording and reproducing data in disc-type recording media, methods therefor, and medium including computer readable code controlling a computer to perform the same. More specifically, the present invention is directed toward data recording and reproducing data in a disc-type recording medium by varying an optical recording power level based on a recording speed of the disc-type recording medium.

2. Description of the Related Art

FIGS. 1A and 1B are graphs illustrating power levels of light, over time, emitted by an optical pickup to record data on a recording medium. More specifically, FIG. 1A illustrates power levels of light emitted by an optical pickup to record data in a CD-R disc-type recording medium. A pit is formed in the recording medium during a light-emitting period between A and B on the time-axis. On the other hand, during the periods when only a read power level is emitted, a pit is not formed. During these periods where only a read power level is emitted, a wobble signal, which can be formed along a track of the recording medium and represents address information, as well as a servo signal, can both be detected by light reflected off the recording medium.

To maintain uniform optical power levels, such as the read power level, during a recording operation, a power level of the light emitted from the pick-up is detected using an optical detection unit, such as a photo diode, and is fed back to an automatic power control (APC) circuit. The APC circuit compares the feedback signal with a reference signal and controls the output read power level to be uniform. However, the read power level can be reduced or fluctuate due to noise, which can increase with higher recording speeds. The power levels can also be reduced or caused to fluctuate due to non-ideal characteristics of parts. Thus, the actual read power level for recording to the recording medium is lower than the preset read power level. As a result, recording quality may be lowered.

FIG. 1B illustrates power levels of light emitted by an optical pickup for recording data in a CD-RW disc-type recording medium. Existing data in the recording medium is erased during the period where the power level of the emitted light is equivalent to the erase power level plus a bias power level. A pit is formed during the period where the power level of the emitted light is equivalent to the peak power level plus the erase power level plus the bias power level. As specifically illustrated in FIG. 1B, data is recorded on the recording medium during a period between X and Y on the time-axis. In the CD-RW disc, the bias power level performs a similar function as the read power level in a CD-R disc. Like the CD-R disc, the CD-RW disc may also suffer from degradation of recording quality because of the bias power level being reduced with increases in recording speeds.

### SUMMARY OF THE INVENTION

Accordingly, it is an aspect of the present invention to provide a data recording or recording and reproducing apparatus, method therefor, and medium including computer readable code to control a computer to perform the same, to minimize degradation of recording quality even when recording speeds increase.

Additional objects and advantages of the invention will be set forth in part in the description which follows and, in part, will be obvious from the description, or may be learned by practice of the invention.

To achieve the above and/or other aspects of the present invention, there is provided a data recording method, including obtaining discrimination information for discriminating a recording medium type of a recording medium inserted into a recording or recording and reproducing apparatus, determining a read power level for reading information from the recording medium based on both the discrimination information and a recording speed for recording data on the recording medium, and recording data on the recording medium using the read power level and at least one recording power level.

To achieve the above and/or other aspects of the present invention, there is provided a data recording or recording and reproducing apparatus including a memory to store discrimination information, for discriminating a recording medium type of a recording medium, and read power level information including recording speeds corresponding to the discrimination information, a pickup driving unit to receive information read off the recording medium from a pickup or to output a signal to control the pickup, and a system control unit to receive the discrimination information of the recording medium from the pickup driving unit, determining a read power level for reading information from the recording medium, based on the read power level information, corresponding to the discrimination information, and outputting a signal reflecting the determined read power to the pickup driving unit.

To achieve the above and/or other aspects of the present invention, there is provided a data recording method including controlling a varying of a read power level of an optical pickup, for reading information from a recording medium, and a recording speed, for recording information to the recording medium, to change predetermined amounts, respectively, based on an area of the recording medium information is to be recorded to, and recording the information to the recording medium using the controlled read power level and recording speed. The read power level and recording speed changes may be based on a determined type of the recording medium.

To achieve the above and/or other aspects of the present invention, there is provided a data recording or recording and reproducing apparatus including a pickup to record information to a recording medium at a variable recording speed, and a controller to control a read power level of an optical pickup, for reading information from the recording medium, to change a predetermined amount as the recording speed changes a predetermined amount. Again, the read power level and recording speed changes may be based on a determined type of the recording medium.

Still further, to achieve the above and/or other aspects of the present invention, there is provided a data recording method controlling a varying of a read power level of an optical pickup, for reading information from a recording medium, and a recording speed, for recording information to the recording medium, to change predetermined amounts, respectively, based on a wobble and/or servo signal read from the recording medium, and recording information to the recording medium at the controlled read power level and recording speed.

In addition, to achieve the above and/or other aspects of the present invention, there is provided data recording or recording and reproducing apparatus a pickup to record information to a recording medium at a variable recording speed, and a controller to control a read power level of an optical pickup, for reading information from the recording medium, to change a predetermined amount based on a change in recording speed of a predetermined amount, which is based on a wobble or servo signal read from the recording medium.

Lastly, to achieve the above and/or other aspects of the present invention, there is also provided a medium including computer readable code controlling a computer to control the execution of aforementioned methods, or a medium including computer readable code controlling a computer to control the operation of the aforementioned data recording or recording and reproducing apparatuses.

These, together with other aspects and/or advantages that will be subsequently apparent, reside in the details of construction and operation as more fully hereinafter described and claimed, reference being had to the accompanying drawings forming a part thereof.

### BRIEF DESCRIPTION OF THE DRAWINGS

These and other objects and advantages of the invention will become apparent and more readily appreciated from the following description of the preferred embodiments taken in conjunction with the accompanying drawings in which:

FIGS. 1A and 1B are graphs illustrating output power levels of light emitted to read and record data to and from a recording medium;

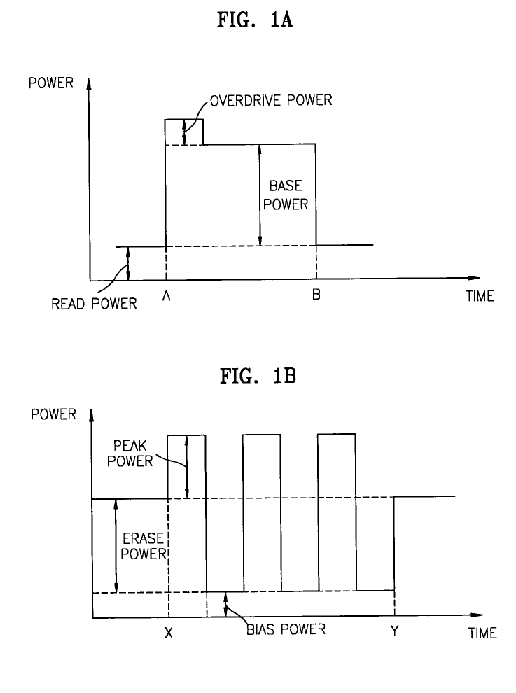

FIG. 2 is a block diagram illustrating a data recording and reproducing apparatus according to an embodiment of the present invention; and

FIG. 3 is a flowchart illustrating a data recording method according to an embodiment of the present invention.

### DETAILED DESCRIPTION OF THE PREFERRED EMBODIMENTS

Reference will now be made in detail to the present preferred embodiments of the present invention, examples of which are illustrated in the accompanying drawings, wherein like reference numerals refer to the like elements throughout. The embodiments are described below in order to explain the present invention by referring to the figures.

Throughout the present application, read power levels refer to optical power levels of light emitted from a pickup to at least read out a wobble signal or servo signal reflecting an address during data recording.

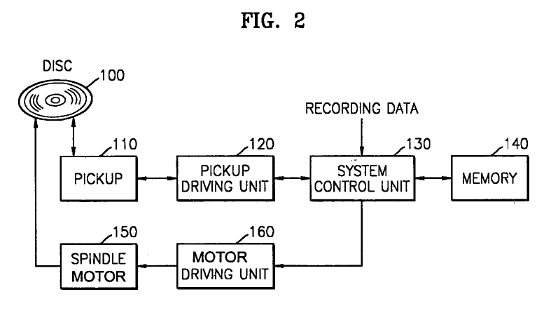

FIG. 2 is a block diagram illustrating a data recording and reproducing apparatus according to an embodiment of the present invention. The data recording apparatus includes a recording medium 100, a pickup 110, a pickup driving unit 120, a system control unit 130, a memory 140, a spindle motor 150, and a motor driving unit 160.

The recording medium 100 is a recording medium capable of optical recording, such as CD-R and CD-RW discs. A wobble signal reflecting an address of a region where data will be recorded can be formed along a track. The address may be changed to an absolute time information reflecting a recording time of data.

The pickup 110 emits light having a read power level to the recording medium 100 prior to data recording, reads the wobble signal from the recording medium 100, and determines an address therefrom where data will be recorded on the recording medium 100. After determining the address for data recording, the pickup 110 emits light to the recording medium 100 so as to form a pit or not to form a pit, thereby producing a region corresponding to data values of “1” or “0”, respectively.

The pickup driving unit 120 controls an operation of the pickup 110 in response to the control of the system control unit 130.

The memory 140 stores optical power level information corresponding to each recording speed for each type of recording medium, e.g., each disc-type recording medium. A recording medium type of the recording medium 100 can be discriminated based on whether the recording medium 100 is CD-R, CD-RW, or DVD, for example. If the recording medium 100 is a CD-R disc, the recording medium 100 would then be discriminated again based on corresponding manufacturer information. Examples of optical power level information corresponding to each recording speed, stored in the memory 140, is shown in the following table.

TABLE 1

| Recording | Read power | Base power | Recording address |
|---|---|---|---|
| speed | (mW) | (mW) | (number) |
| 16× | 1.6 | 20 | 0˜36,992 |
| 20× | 1.7 | 30 | 36,993˜86,927 |
| 24× | 1.8 | 40 | 86,928˜145,931 |
| 28× | 2.0 | 50 | 145,932˜215,917 |
| 32× | 2.5 | 60 | 215,918˜End |

In conventional methods, read power levels are fixed to a uniform value, for example, 1.5 mW, regardless of a recording speed. However, in the present invention, as shown in Table 1, the read power level can be augmented based on an increase in recording speed. The base power and overdrive power can be determined by conventional methods.

When power is supplied to the recording and reproducing apparatus illustrated in FIG. 2, which may also merely be a recording apparatus without a reproducing capability, the system control unit 130 reads out optical power level information for each recording medium type and for each recording speed. Next, when recording medium 100 is inserted into the recording and/or reproducing apparatus, the system control unit 130 reads out discrimination information recorded in the recording medium 100, e.g., information on whether the recording medium 100 is a CD-R disc or a CD-RW disc and information regarding the manufacturer of the disc, and then determines a recording medium type. The system control unit 130 receives data to be recorded in response to a data recording command from a user, and controls the pickup driving unit 120, so as to emit light having a particular optical power level for each recording speed, corresponding to the determined discrimination information of the disc. As a result, recording data is recorded in the recording medium 100.

Hereinafter, operations of the system control unit 130 will be described in detail with reference to Table 1. In the case where the system control unit 130 receives a data input command from a user and thus records data starting from address number 0 of a disc-type recording medium, for example, data is recorded from address number 0, which may be the most inner portion of a data region of the disc, to address number 36,992, at a recording speed of 16× and with a read power level of 1.6 mV, a base power level of 20 mV, and an overdrive power level of 15% to 25% of the base power level.

Data is recorded by forming or not forming a pit on the disc. While light corresponding to the read power level is emitted to the disc, a pit is not formed, thereby resulting in the production of a region representing a data value of “0.” Then, a light-receiving element (not shown), such as a photo diode in the pickup 110, receives a reflected light from the disc and outputs a current signal proportional to the power level of the reflected light. The current signal is then processed to determine the next address where data will be recorded and to produce a servo signal. For example, the system control unit 130 reads out the wobble and servo signals with a read power of 1.6 mW at a speed of 16×, and records data from number 0 to number 36,992. When the system control unit 130 determines from the read wobble signal that the next address number is 36,993, the motor driving unit 169 is then controlled to increase the recording speed up to a speed of 20× and the pickup driving unit 120 is controlled to increase the read power level from 1.6 mW to 1.7 mW. As described above, as a recording speed for recording data in a recording medium increases, the read power level can be augmented so as to increase the power level of light reflected from the recording medium. A benefit of this augmentation is that the signal to noise ratio (SNR) is improved. Accordingly, as light of a corresponding read power level is emitted to the recording medium, the quality of servo and wobble signal determination is greatly improved. An improvement in the servo signal increases the accuracy of the servo, thereby optimizing recording quality.

The spindle motor 150 directly spins the recording medium 100 such that the recording medium 100 is spun at a desired speed, in response to the control of the motor driving unit 160.

The motor driving unit 160 controls the spin of the spindle motor 150, in response to the control of the system control unit 130.

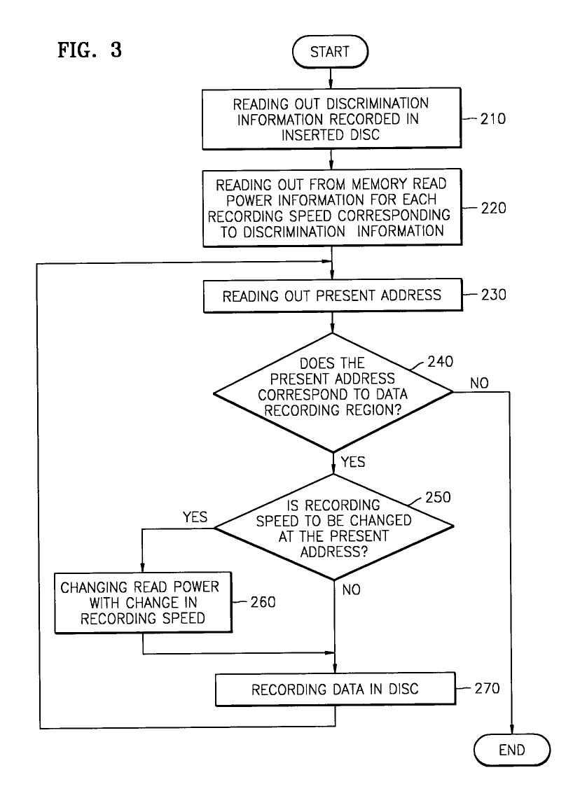

FIG. 3 is a flowchart illustrating a data recording method according to an embodiment of the present invention.

When a disc is inserted in the recording and reproducing apparatus of FIG. 2, for example, the system control unit 130 reads out discrimination information recorded in the disc, e.g., information on whether the disc is CD-R or CD-RW and the manufacturer of the disc, and thus determines a disc type (operation 210).

The system control unit 130 refers to the discrimination information of the disc and thus reads out each optical power level information for each recording speed, corresponding to the discrimination information, from the memory 140 (operation 220).

The system control unit 130 receives the present address, where data obtained from reflected light of the light emitted at the read power will be recorded (operation 230).

The system control unit 130 determines whether the present address corresponds to a data recording region (operation 240). If the present data does not correspond to a data recording region, the data recording is completed.

If the present address corresponds to a data recording region, the system control unit 130 determines whether a recording speed is to be changed at the present address (operation 250). As shown in Table 1, address numbers 36,993, 86,928, 145,932, and 215,918 correspond to addresses where the recording speed is changed.

If the recording speed is to be changed, at the present address, the system control unit 130 controls the motor driving unit 169 to change the recording speed and controls the pickup driving unit 120 to change the read power level with the change in the recording speed (operation 260).

The system control unit 130 controls data to be recorded in the disc 100 based on the determined recording speed and read power level (operation 270). In the case of a recording apparatus for recording data in a CD-R disc, the system control unit 130 can be set to an initialization value such that data is initially recorded at a recording speed of 16×, with a read power level of 1.6 mW.

Embodiments of the present invention may be embodied in a general purpose digital computer, or computers, by running a program from a computer readable medium, including but not limited to storage media such as magnetic storage media (e.g., ROMs, floppy discs hard discs, etc.), optically readable media (e.g., CD-ROMs, DVDs, etc.) and carrier waves (e.g., transmissions over the Internet). The computer readable recording medium can also be dispersively installed in a computer system connected to a network, and stored and executed as a computer readable code by a distributed computing environment.

As set forth above, a data recording or recording and reproducing apparatus, method, and computer readable medium, according to embodiments of the present invention, can control the augmentation of read power levels in proportion to increases in a recording speed for recording data in a recording medium. Thus, reproduction quality of servo and wobble signals are improved. Further, as the servo signal is improved in quality, the accuracy of the servo of the recording apparatus is increased, which leads to improvements in recording quality.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A data recording method, comprising:
obtaining discrimination information for discriminating a recording medium type of a recording medium inserted into a recording or recording and reproducing apparatus;
determining a read power level for reading information from the recording medium based on both the discrimination information and a recording speed for recording data on the recording medium; and
recording data on the recording medium using the read power level and at least one recording power level.

2. The method as claimed in claim 1, further comprising increasing the read power level by a predetermined value in proportion to an increase in the recording speed.

3. The method as claimed in claim 1, wherein the determining of the read power level further comprises:
reading out read power level information, from a memory, for recording speeds of the recording medium corresponding to the discrimination information;
reading out a recording address where data will be recorded on the recording medium;
determining a read power level corresponding to a recording speed at a recording medium region having the recording address, based on the read power level information; and
reading out another address and determining a read power level corresponding to a recording speed at a recording medium region having the other address, based on the read power level information.

4. The method as claimed in claim 1, wherein the determining of the read power level further comprises:
reading out, from a memory, read power level information for recording speeds of the recording medium corresponding to the discrimination information;
reading out a recording address where data will be recorded on the recording medium;
determining whether the recording address corresponds to a data recording region of the recording medium;
determining whether a current recording speed should be changed for recording at the recording address if the recording address corresponds to the data recording region in the recording medium;
determining the read power level corresponding to a new recording speed at the recording medium region having the recording address based on the read power level information if the current recording speed should be changed at the recording address; and
reading out another recording address, determining whether the other recording address corresponds to a data recording region in the recording medium, determining whether the new or current recording speed should be changed to a recording speed for recording at the other recording address, and determining the read power level corresponding to the recording speed for recording at the other recording address.

5. A data recording or recording and reproducing apparatus, comprising:
a memory to store discrimination information, for discriminating a recording medium type of a recording medium, and read power level information including recording speeds corresponding to the discrimination information;
a pickup driving unit to receive information read off the recording medium from a pickup or to output a signal to control the pickup; and
a system control unit to receive the discrimination information of the recording medium from the pickup driving unit, determining a read power level for reading information from the recording medium, based on the read power level information, corresponding to the discrimination information, and outputting a signal reflecting the determined read power to the pickup driving unit.

6. The apparatus as claimed in claim 5, wherein the memory stores read power level information, with individual read power levels increasing with increases in recording speed.

7. The apparatus as claimed in claim 5, wherein the system control unit receives a recording address, where data will be recorded on the recording medium, from the pickup driving unit, and determines a read power level corresponding to a data recording speed at the recording medium region containing the recording address, based on the read power level information stored in the memory.

8. The apparatus as claimed in claim 5, wherein the system control unit receives a recording address, where data will be recorded on the recording medium, from the pickup driving unit, determines whether the recording address is a last recording address where data will be recorded in the recording medium, determines whether the recording speed should be changed for recording at the recording address if the recording address is not the last recording address, and determines a read power level corresponding to a new recording speed for recording in a region containing the recording address, based on the read power level information if the recording speed should be changed at the recording address.

9. A data recording method, comprising:
controlling a varying of a read power level of an optical pickup, for reading information from a recording medium, and a recording speed, for recording information to the recording medium, to change predetermined amounts, respectively, based on an area of the recording medium information which is to be recorded to; and
recording the information to the recording medium using the controlled read power level and recording speed.

10. The method as claimed in claim 9, wherein the read power level and recording speed changes are based on a determined type of the recording medium.

11. A data recording or recording and reproducing apparatus, comprising:
a pickup to record information to a recording medium at a variable recording speed; and
a controller to control a read power level of an optical pickup, for reading information from the recording medium, to change a predetermined amount as the recording speed changes a predetermined amount.

12. The apparatus as claimed in claim 11, wherein the read power level and recording speed changes are based on a determined type of the recording medium.

13. A data recording method, comprising:
controlling a varying of a read power level of an optical pickup, for reading information from a recording medium, and a recording speed, for recording information to the recording medium, to change predetermined amounts, respectively, based on a wobble and/or servo signal read from the recording medium; and
recording information to the recording medium at the controlled read power level and recording speed.

14. The method according to claim 13, wherein the wobble signal indicates an address of the recording medium, and the recording speed is varied based on the address being in a data recording region of the recording medium and being one of a plurality of predetermined address numbers.

15. The apparatus according to claim 14, wherein the plurality of predetermined address numbers includes at least one of address numbers 36,993, 86,928, 145,932, and 215,918.

16. A data recording or recording and reproducing apparatus comprising:
a pickup to record information to a recording medium at a variable recording speed; and
a controller to control a read power level of an optical pickup, for reading information from the recording medium, to change a predetermined amount based on a change in recording speed of a predetermined amount, which is based on a wobble or servo signal read from the recording medium.

17. The apparatus according to claim 16, wherein the wobble signal indicates an address of the recording medium, and the recording speed is varied based on the address being in a data recording region of the recording medium and being one of a plurality of predetermined address numbers.

18. The apparatus according to claim 17, wherein the plurality of predetermined address numbers includes at least one of address numbers 36,993, 86,928, 145,932, and 215,918.

19. A data recording method, comprising augmenting a read power level of an optical pickup in proportion to increases in a recording speed, for recording data to a recording medium, using the optical pickup.

20. A data recording or recording and reproducing apparatus, comprising:
an optical pickup; and
a controller to control an augmentation of a read power level of the optical pickup in proportion to increases in a recording speed for recording data to a recording medium.

21. A medium comprising computer readable code controlling a computer to control the execution of the method of claim 1.

22. A medium comprising computer readable code controlling a computer to control the execution of the method of claim 9.

23. A medium comprising computer readable code controlling a computer to control the execution of the method of claim 13.

24. A medium comprising computer readable code controlling a computer to control the execution of the method of claim 19.

25. A medium comprising computer readable code controlling a computer to control the operation of the data recording or recording and reproducing apparatus of claim 5.

26. A medium comprising computer readable code controlling a computer to control the operation of the data recording or recording and reproducing apparatus of claim 11.

27. A medium comprising computer readable code controlling a computer to control the operation of the data recording or recording and reproducing apparatus of claim 16.

28. A medium comprising computer readable code controlling a computer to control the operation of the data recording or recording and reproducing apparatus of claim 20.
